(19) United States
(12) Patent Application Publication
(10) Pub. No.: US 2015/0091847 A1
(43) Pub. Date: Apr. 2, 2015

(54) TOUCH CONTROL DETECTING APPARATUS AND METHOD THEREOF

(71) Applicant: Novatek Microelectronics Corp., Hsinchu (TW)

(72) Inventor: Chih-Yuan Chang, Hsinchu County (TW)

(73) Assignee: Novatek Microelectronics Corp., Hsinchu (TW)

(21) Appl. No.: 14/210,468

(22) Filed: Mar. 14, 2014

(30) Foreign Application Priority Data
Oct. 2, 2013 (TW) 102135760

(51) Int. Cl. G06F 3/044

(52) U.S. Cl. CPC G06F 3/044
USPC 345/174

(57) ABSTRACT

A touch control detecting apparatus and method are provided. The touch control detecting method is adapted for a touch panel which has a plurality of touch rows and touch columns. The touch control detecting method includes: executing a mutual capacitor touch detection and a self-capacitor touch detection on the touch panel simultaneously, and obtaining a mutual capacitor touch detecting result and a self-capacitor touch detecting result respectively; and then executing an operation on the mutual capacitor touch detecting result and the self-capacitor touch detecting result to obtain position information of at least one touch point on the touch panel.

### CROSS-REFERENCE TO RELATED APPLICATION

This application claims the priority benefit of Taiwan application serial no. 102135760, filed on Oct. 2, 2013. The entirety of the above-mentioned patent application is hereby incorporated by reference herein and made a part of this specification.

### BACKGROUND OF THE INVENTION

1. Field of the Invention

The invention relates to a touch control detecting apparatus and a method thereof

2. Description of Related Art

In the present technical developments, it has become a basic requirement for a touch control apparatus to provide touch control techniques capable of detecting multiple-point touches. In addition, a mutual capacitor touch detection is more accurate than a self-capacitor touch detection in executing detection of the multiple-point touches. However, in the mean time that a capacitor variation of a touch panel is detected, difficulty in detecting position information of a touch point may arise due to operational mode of the user (hand-held or not), whether the touch control apparatus is being charged, and noise interferences from the nature (such as moisture, temperature/humidity, and electromagnetic waves).

In the conventional technical field, the difficulty about detecting the position information of the touch point is usually overcome by arranging an additional hardware or a specifically-designed firmware. Alternatively, among the conventional techniques, a practice of executing an additional self-capacitor touch detection while executing the mutual capacitor touch detection on the touch panel is also introduced. However, such a practice obviously requires a long touch detecting time, which is more obvious especially when applied to a large-size touch panel. In addition, the requirement for longer touch detecting time reduces touch control sensitivity.

### SUMMARY OF THE INVENTION

A touch control detecting apparatus and method thereof are provided, which effectively enhance the efficiency of a touch detection.

The touch control detecting method is adapted for a touch panel which has a plurality of touch rows and touch columns. The touch control detecting method includes: executing a mutual capacitor touch detection and a self-capacitor touch detection on the touch panel simultaneously, and obtaining a mutual capacitor touch detecting result and a self-capacitor touch detecting result respectively; and then executing an operation on the mutual capacitor touch detecting result and the self-capacitor touch detecting result to obtain position information of at least one touch point on the touch panel.

A touch control detecting apparatus is provided, including a touch panel and a touch detecting controller. The touch panel has a plurality of touch rows and touch columns, and the touch detecting controller is coupled to the touch rows and the touch columns. The touch detecting controller executes a mutual capacitor touch detection and a self-capacitor touch detection simultaneously to obtain a mutual capacitor detecting result and a self-capacitor detecting result respectively, and then executes an operation on the mutual capacitor touch detecting result and the self-capacitor touch detecting result to obtain position information of at least one touch point on the touch panel.

Based on the above, the invention effectively reduces the time required for detection by executing the mutual capacitor touch detection and the self-capacitor touch detection synchronically. In addition, the invention obtains the position information of the touch point with a combination of the mutual capacitor detection result and the self-capacitor detection result simultaneously, so that the position information of the touch point may be detected accurately. Thus, the touch control detecting method provided herein is able to detect the position information of the touch point rapidly and accurately, which enhances the overall executeance of the touch control detecting apparatus.

To make the above features and advantages of the invention more comprehensible, several embodiments accompanied with drawings are described in detail as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a flow chart showing a touch control detecting method according to an embodiment.

FIGS. 2A-2C illustrate multiple examples of the embodiment respectively.

FIG. 3A illustrates a schematic diagram showing a touch control detecting apparatus according to an embodiment.

FIG. 3B illustrates an example of the embodiment of the touch control detecting apparatus.

FIG. 4A illustrates a schematic diagram showing a part of a circuit of the touch control detecting apparatus according to the embodiment.

FIG. 4B illustrates a waveform showing touch detecting actions of the touch control detecting apparatus according to the embodiment.

### DESCRIPTION OF EMBODIMENTS

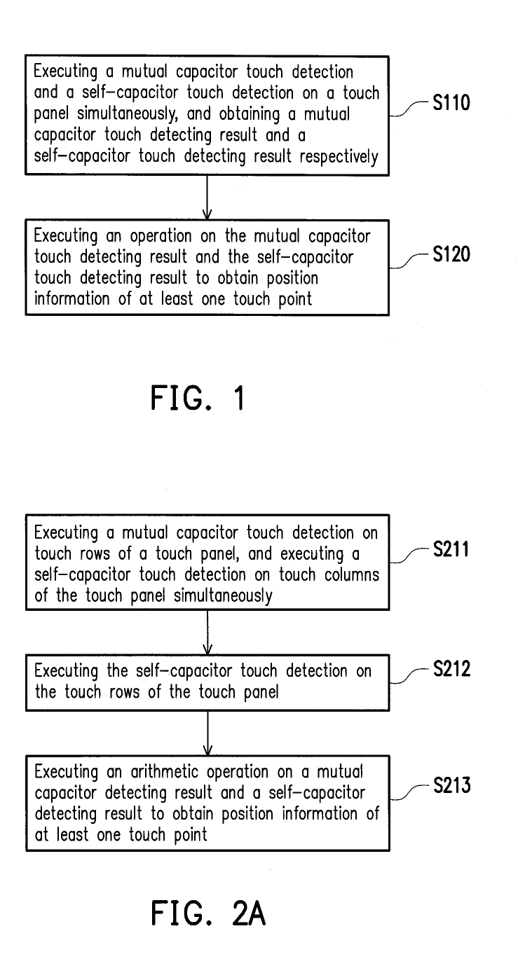

Referring to FIG. 1, FIG. 1 illustrates a flow chart showing a touch control detecting method according to an embodiment. Therein, the touch control detecting method is adapted for a touch panel which has a plurality of touch rows and touch columns. The touch control detecting method includes steps of: firstly, in a step S110, executing a self-capacitor touch detection and a mutual capacitor touch detection simultaneously on the touch panel, wherein a self-capacitor detecting result is obtained by the executed self-capacitor touch detection, and a mutual capacitor detecting result is obtained by the executed mutual capacitor touch detection.

Next, in a step S120, an arithmetical operation is executed on the self-capacitor touch detecting result and the mutual capacitor touch detecting result obtained in the step S110, and position information of one or more touch points is obtained from the result of the arithmetical operation.

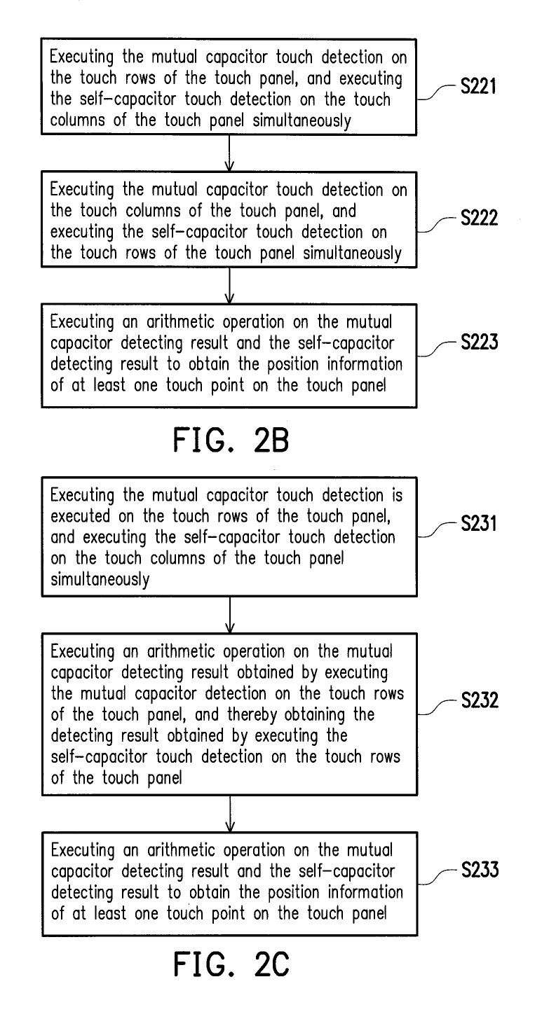

Referring to FIGS. 2A-2C for the descriptions below, FIGS. 2A-2C respectively illustrate multiple examples of the embodiment. In FIG. 2A, the mutual capacitor touch detection is executed on the touch rows of the touch panel in a step S211, and the self-capacitor touch detection is executed on the touch columns of the touch panel while the mutual capacitor touch detection is executed. More specifically, in the step S211, the touch rows of the touch panel receive a touch driving signal and take the touch columns of the touch panel as receiving terminals to receive variations in electrical properties (such as variations in voltages) caused by the touch driving signal to execute the mutual capacitor touch detection of the touch panel. It is worth noting that according to the touch driving signal received by the touch rows of the touch panel, self-capacitor touch detecting actions may also be executed on the touch columns of the touch panel by measuring variations in electrical properties on the touch columns of the touch panel in the present example.

Next, in a step S212, self-capacitor touch detecting actions are executed on the touch rows of the touch panel. Moreover, combining the touch detecting results obtained in the steps S211 and S212, complete mutual capacitor detecting result and self-capacitor detecting result are obtained in the present example, and the position information of one or more touch points is calculated accurately by an arithmetic operation of the mutual capacitor detecting result and the self-capacitor detecting result executed in a step S213.

In addition, in the example of FIG. 2B, in a step S221, the mutual capacitor touch detection is executed on the touch rows of the touch panel, and the self-capacitor touch detection is executed on the touch columns of the touch panel while executing the mutual capacitor touch detection. That is, the touch columns of the touch panel are used as transmitting terminals to transmit the touch driving signal, and the touch rows of the touch panel are used as receiving terminals to receive variations in the electrical properties caused by the touch driving signal, so as to execute the mutual capacitor touch detection. Moreover, while the touch rows of the touch panel are used to receive the touch driving signal, the self-capacitor touch detection is executed on the touch columns of the touch panel by measuring the variations in the electrical properties on the touch columns of the touch panel.

Next, in a step S222, the mutual capacitor touch detection is executed on the touch columns of the touch panel, and the self-capacitor touch detection is executed on the touch rows of the touch panel while the mutual capacitor touch detection is executed. More specifically, the step switches to use the touch rows of the touch panel as the transmitting terminals to transmit the touch driving signal, and to use the touch columns of the touch panel as the receiving terminals to receive variations in the electrical properties caused by the touch driving signal, so as to execute the mutual capacitor touch detection. Moreover, while the touch columns of the touch panel are used for receiving the touch driving signal, the self-capacitor touch detection is executed on the touch rows of the touch panel by measuring the variations in the electrical properties on the touch columns of the touch panel.

Combining the touch detecting results in the steps S221 and S222, the mutual capacitor detecting result and the self-capacitor detecting result are obtained, and in a step S223, the position information of one or more touch points is obtained by executing an arithmetic operation of the mutual capacitor detecting result and the self-capacitor detecting result.

In FIG. 2C, in a step S231, the mutual capacitor touch detection is executed on the touch rows of the touch panel, and the self-capacitor touch detection is executed on the touch columns of the touch panel while the mutual capacitor touch detection is executed. That is, the touch columns of the touch panel are used as transmitting terminals to transmit the touch driving signal, and the touch rows of the touch panel are used as receiving terminals to receive variations in electrical properties caused by the touch driving signal, so as to execute mutual capacitor touch detection. Moreover, while the touch rows of the touch panel are used for receiving the touch driving signal, the self-capacitor touch detection is executed on the touch columns of the touch panel by measuring the variations in the electrical properties on the touch columns of the touch panel.

In addition, in a step S232, an arithmetic operation is executed on the mutual capacitor detecting result executed in the step S231, so as to obtain the self-capacitor touch detecting result executed on the touch rows of the touch panel. For instance, variations in mutual capacitance between each of the touch rows corresponding to each of the touch columns are obtained in the step S231, and by adding up variations in the mutual capacitance of a plurality of touch columns corresponding to each of the touch rows, variations in self capacitance corresponding to each touch row are obtained, i.e., the self-capacitor touch detecting result of the touch rows of the touch panel is obtained.

Combining the detecting results in the steps S231 and S232, the mutual capacitor detecting result and the self-capacitor detecting result are obtained, and in a step S233, the position information of one or more touch points is obtained by executing an arithmetic operation on the mutual capacitor detecting result and the self-capacitor detecting result.

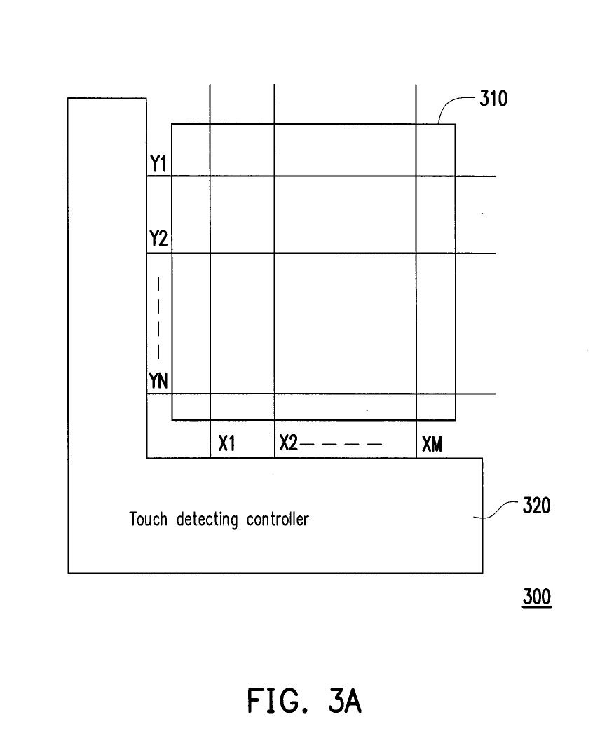

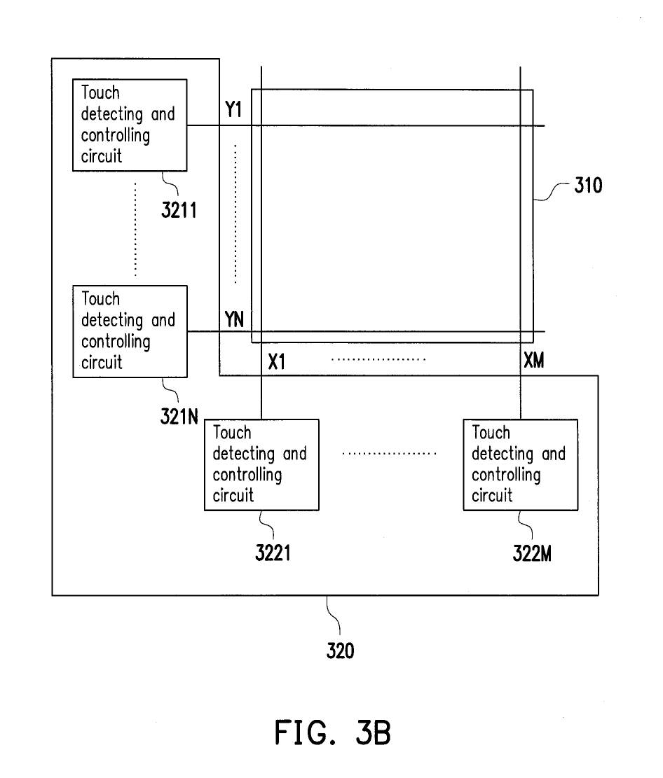

Referring to FIG. 3A, FIG. 3A illustrates a schematic diagram showing a touch control detecting apparatus according to an embodiment. A touch control detecting apparatus 300 includes a touch panel 310 and a touch detecting controller 320. The touch panel 310 has a plurality of touch rows X1-XM and a plurality of touch columns Y1-YN. The touch detecting controller 320 is coupled to the touch rows X1-XM and the touch columns Y1-YN of the touch panel 310, and executes mutual capacitor and self-capacitor touch detections on the touch panel 310.

The touch detecting controller 320 is able to execute self-capacitor the touch detection and the mutual capacitor touch detection on the touch panel 310 simultaneously. More specifically, the touch detecting controller 320 configures the touch rows X1-XM as the transmitting terminals to transmit a touch driving signal, and the touch detecting controller 320 also configures the touch columns Y1-YN as the receiving terminals to receive variations in electrical properties caused by the touch driving signal, thereby executing the mutual capacitor touch detection on the touch columns Y1-YN. Simultaneously, the touch detecting controller 320 weighs variations of the touch rows X1-XM in the electrical properties caused by the touch driving signal, and thereby executes the self-capacitor touch detection on the touch rows X1-XM.

Please note here that the touch driving signal is a signal that enables the variations in the electrical properties at the terminal coupled by the touch rows X1-XM to the touch detecting controller 320. Take changing a voltage on a terminal coupled by the touch rows X1-XM to the touch detecting controller 320 for example, the touch driving signal may be a square wave, a triangular wave, a step wave or other kinds of periodic signals.

Referring to FIG. 3B, FIG. 3B illustrates an example of the embodiment of the touch control detecting apparatus. Therein, the touch detecting controller 320 includes a plurality of touch detecting and controlling circuits 3211-321N and 3221-322M. In FIG. 3B, the touch detecting and controlling circuits 3211-321N and 3221-322M are coupled respectively to the touch columns Y1-YN and the touch rows X1-XM. The touch detecting and controlling circuits 3211-321N and 3221-322M further execute the mutual capacitor touch detection and/or the self-capacitor touch detection on the touch columns Y1-YN and the touch rows X1-XM.

It is worth noting that there is not necessarily one-on-one coupling between the touch detecting and controlling circuits and the touch rows and the touch columns. In other examples, a plurality of touch rows (columns) may share a touch detecting and controlling circuit and execute touch detecting actions in a manner of time-division multiplexing. The implementing details of the time-division multiplexing should be familiar to person having ordinary skill in the art and would not be elaborated herein.

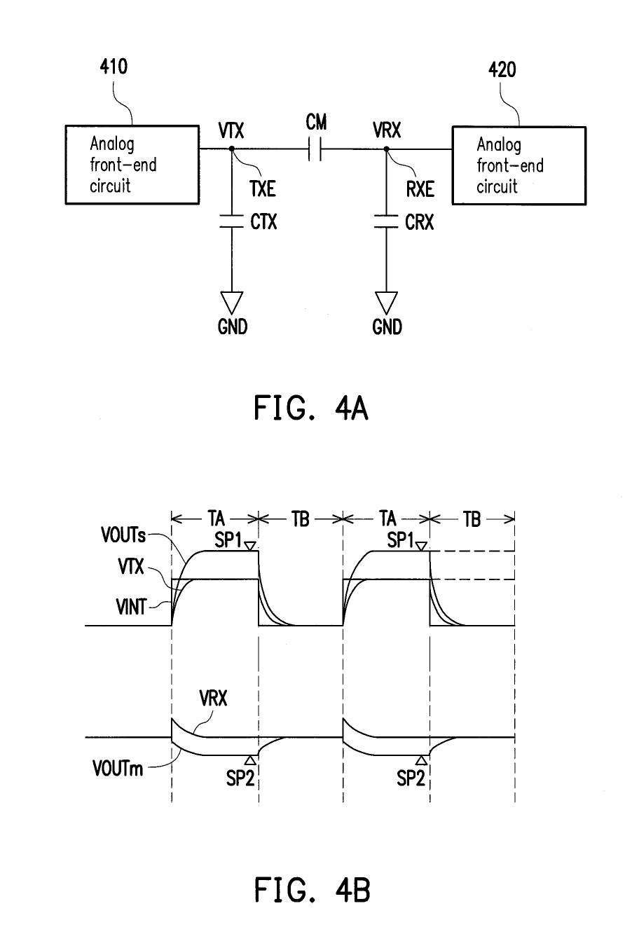

Referring to FIGS. 4A and 4B, FIG. 4A illustrates a schematic diagram showing a part of a circuit of the touch control detecting apparatus according to the embodiment. On the other hand, FIG. 4B illustrates a waveform showing touch detecting actions of the touch control detecting apparatus according to the embodiment. In FIG. 4A, analog front-end circuits 410 and 420 are respectively disposed in different touch detecting and controlling circuits. Moreover, the analog front-end circuit 410 is coupled, for example, to a touch column that serves as the transmitting terminal, wherein the analog front-end circuit 410 and the touch column are coupled to a transmitting end TXE. In addition, the analog front-end circuit 420 is coupled, for example, to a touch row that serves as the receiving terminal, wherein the analog front-end circuit 420 and the touch row are coupled to a receiving end RXE.

In FIG. 4A, the transmitting end TXE and the receiving end RXE have a mutual capacitor CM, and there is a self-capacitor CTX between the transmitting end TXE and a ground end GND and a self-capacitor capacitor CRX between the receiving end RXE and the ground end GND.

When the mutual capacitor touch detection is to be executed, the analogue front-end circuit 410 provides the touch driving signal onto the transmitting end TXE and changes a voltage VTX. According to the change of the voltage VTX on the transmitting end TXE, a voltage VRX on the receiving end RXE also changes correspondingly. At this point, the analogue front-end circuit 420 receives the voltage VRX on the receiving end RXE and obtains a mutual capacitor touch detecting result on the touch row by weighing the change in the voltage value of the voltage VRX or the change in the current of the voltage end VRX.

In the mean time, the analogue front-end circuit 410 is able to execute the self-capacitor touch detection on the touch column according to the changes in the voltage VTX, so as to obtain a self-capacitor detecting result.

Referring to both FIGS. 4A and 4B for the descriptions below, in a time period TA, the analogue front-end circuit 410 provides a high-voltage touch driving signal VINT to the transmitting end TXE. Due to the influences of the self-capacitors CTX and CRX and the mutual capacitor CM, the voltages VTX and VRX have different changing trends according to the variations in capacitance values of the self-capacitors CTX and CRX and the mutual capacitor CM at that point of time. Therein, the analogue front-end circuit 410 generates a detecting voltage VOUTs according to the variations in the detecting voltage VTX and generates the self-capacitor touch detecting result according to whether a voltage value of the detecting voltage VOUTs at a sampling point SP1 exceeds a predetermined threshold. In contrast, the analogue front-end circuit 420 generates a detecting voltage VOUTm according to the variations in the detecting voltage VRX or the variations in the current on the receiving end RXE and generates the mutual capacitor touch detecting result according to whether a voltage value of the detecting voltage VOUTm at a sampling point SP2 exceeds another predetermined threshold.

The predetermined threshold is set by obtaining a reference value from an output voltage of the analogue front-end circuit when no touch event occurs on the touch panel, and the designer may further add or subtract a predetermined deviation to/from the reference value to set predetermined thresholds. The predetermined deviation may be set according to the actual working status of the touch panel.

By the way, in a time block TB, an analog-to-digital conversion (A/D) may be executed on the detecting voltages VOUTm and VOUTs, wherein an A/D circuit may be constructed in the touch detecting and coltrolling circuit.

In light of the above, the invention obtains the mutual capacitor detecting result and the self-capacitor detecting result within a least period of time by simultaneously executing the mutual capacitor detecting and self-capacitor detecting actions on the touch panel. Moreover, the position information of at least one touch point on the touch panel is obtained by executing an operation on the mutual capacitor detecting result and the self-capacitor detecting result. Thus, in addition to detecting the position information of the touch point accurately, the same is done within the shortest period of time, so as to avoid delayed reaction to a user's touch control action and enhance the usage efficiency of the touch control apparatus.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A touch control detecting method, adapted for a touch panel which has a plurality of touch rows and touch columns, comprising:
executing a mutual capacitor touch detection and a self-capacitor touch detection on the touch panel simultaneously and obtaining a mutual capacitor touch detecting result and a self-capacitor touch detecting result respectively; and
executing an operation on the mutual capacitor touch detecting result and the self-capacitor touch detecting result to obtain position information of at least one touch point on the touch panel.

2. The touch control detecting method according to claim 1, wherein executing the mutual capacitor touch detection and the self-capacitor touch detection on the touch panel simultaneously comprises a step of:
executing the mutual capacitor touch detection on the touch rows of the touch panel and executing the self-capacitor touch detection on the touch columns of the touch panel simultaneously.

3. The touch control detecting method according to claim 2, further comprising:
executing the self-capacitor touch detection on the touch rows of the touch panel.

4. The touch control detecting method according to claim 2, wherein executing the mutual capacitor touch detection on the touch rows of the touch panel and executing the self-capacitor touch detection on the touch columns of the touch panel simultaneously comprises steps of:
providing a touch driving signal to each of the touch columns and executing the mutual capacitor touch detection on the touch rows corresponding to each of the touch columns; and
executing the self-capacitor touch detection on each of the touch columns according to the touch driving signal simultaneously.

5. The touch control detecting method according to claim 2, further comprising:
executing the mutual capacitor touch detection on the touch columns of the touch panel and executing the self-capacitor touch detection on the touch rows of the touch panel simultaneously.

6. The touch control detecting method according to claim 5, wherein executing the mutual capacitor touch detection on the touch columns of the touch panel and executing the self-capacitor touch detection on the touch rows of the touch panel simultaneously comprises steps of:
providing a touch driving signal to each of the touch rows and executing the mutual capacitor touch detection on the touch columns corresponding to each of the touch rows; and
executing the self-capacitor touch detection on each of the touch rows according to the touch driving signal simultaneously.

7. The touch control detecting method according to claim 2, further comprising:
executing an arithmetic operation on the mutual capacitor detecting result obtained by executing the mutual capacitor touch detection on the touch rows of the touch panel, and thereby obtaining the detecting result obtained by executing the self-capacitor touch detection on the touch rows of the touch panel.

8. A touch control detecting apparatus, comprising:
a touch panel, having a plurality of touch rows and touch columns; and
a touch detecting controller, coupled to the touch rows and the touch columns, wherein the touch detecting controller executes a mutual capacitor touch detection and a self-capacitor touch detection simultaneously on the touch panel to obtain a mutual capacitor detecting result and a self-capacitor detecting result, and executes an operation on the mutual capacitor detecting result and the self-capacitor detecting result to obtain position information of at least one touch point on the touch panel.

9. The touch control detecting method according to claim 8, wherein the touch detecting controller executes the mutual capacitor touch detection on the touch rows of the touch panel and executes the self-capacitor touch detection on the touch columns of the touch panel simultaneously.

10. The touch control detecting apparatus according to claim 8, wherein the touch detecting controller further executes the self-capacitor touch detection on the touch rows of the touch panel.

11. The touch control detecting apparatus according to claim 8, wherein the touch detecting controller further executes the mutual capacitor touch detection on the touch columns of the touch panel and executes the self-capacitor touch detection on the touch rows of the touch panel simultaneously.

12. The touch control detecting apparatus according to claim 8, wherein the touch control detecting apparatus further executes an arithmetic operation on the mutual capacitor detecting result obtained by executing the mutual capacitor touch detection on the touch rows of the touch panel, and thereby obtains the detecting result obtained by executing the self-capacitor touch detection on the touch rows of the touch panel.

13. The touch control detecting apparatus according to claim 8, wherein the touch detecting controller comprises a plurality of touch detecting and controlling circuits, each of the touch detecting and controlling circuits comprising:
an analog front-end circuit, coupled to one of the touch rows and the touch columns for sensing variations in the electrical properties in one of the touch rows and the touch columns, and thereby executing the self-capacitor touch detection or the mutual capacitor touch detection on one of the touch rows and the touch columns.

14. The touch control detecting apparatus according to claim 8, wherein the touch detecting controller provides a touch driving signal to each of the touch rows to execute the mutual capacitor touch detection on the touch columns, or the touch detecting controller provides the touch driving signal to each of the touch columns to execute the mutual capacitor touch detection on the touch rows.
